(19) United States
(12) Patent Application Publication
(10) Pub. No.: US 2012/0254149 A1
(43) Pub. Date: Oct. 4, 2012

(54) BRAND RESULTS RANKING PROCESS BASED ON DEGREE OF POSITIVE OR NEGATIVE COMMENTS ABOUT BRANDS RELATED TO SEARCH REQUEST TERMS

(75) Inventor: Ronald A. RAMSAY, Levittown, PA (US)

(73) Assignee: PEERVYNE, INC., Levittown, PA (US)

(21) Appl. No.: 13/075,041

(22) Filed: Mar. 29, 2011

(51) Int. Cl. G06F 17/30

(52) U.S. Cl. 707/709; 707/E17.108

(57) ABSTRACT

An automated method is described for displaying brand results in response to a search query. A search query that includes one or more search terms is received at a processor. The one or more search terms are associated with one or more brands. Brand ratings are retrieved for the one or more brands from a memory that stores brand ratings for a plurality of brands. The brand ratings are based upon an analysis of web content items that mention the brands. A web page display of brand results is generated that shows links to one or more web pages of the one or more brands that the one or more search terms are associated with. The links to the one or more web pages of the brands with the most positive brand rating are displayed first.

### BACKGROUND OF THE INVENTION

A large percentage of search queries entered into search engines are attempts by users to learn more about a product (goods) or service that they wish to purchase and/or use. Users often enter general terms such as “smart phones,” “washing machines,” “SUVs,” and “plumbers” into search engines. Other word may be added, such as “best” or a geographic location in an attempt to increase the relevance of the search results. Virtually all search engines process these search requests by delivering the most relevant “organic search results,” as determined based on the specific algorithm used by the search engine. Organic search results are listings on search engine results pages that appear because of their relevance to the search terms. Advertisements, such as pay-per-click advertisements, are not part of the organic search results.

Delivery of advertisements on search result pages is well-known. In a typical scenario, an advertisement will be displayed when a keyword query matches an advertiser's keyword list, or when a content site displays relevant content. Such advertisements are called “sponsored links” or “sponsored ads” and appear adjacent to or above organic results on search engine results pages, or anywhere a web developer chooses to place them on a search result display or a content site. Google AdWords®, Yahoo!® Search Marketing, and Microsoft® adCenter are three well-known systems for ad delivery. Bidding processes are often used to determine which company's ads will be shown and/or the ordering of the ads. The more a company is willing to bid, the more likely that their ads will appear in a favorable location if a specific keyword exists in a search query.

The presentation of the ads and the ordering of the ads have nothing to do with the quality of the advertised products or services, as determined by the consuming public. The organic search results are typically based on algorithms that weight the relevance of the search query to web pages that include the terms in the search query and the sponsored ads are based on a bidding process or some other form of paid process. Thus, a user who enters a search request hoping to learn more about a particular product or service that relates to the search query will not necessarily receive search results that will allow them to quickly navigate to a webpage of the brands most liked by the consuming public. For example, FIG. 1 shows the search results for the search query, “bicycles.” The first two organic results are for bicycle manufacturers, the third organic result is shopping results, and the fourth organic result is a bicycle retailer. The most prominent sponsored ad is also a bicycle retailer. These bicycle manufacturers and retailers are not necessarily the brands most liked by the consuming public.

Systems that rank brands based on positive or negative keywords regarding the brand, and then use this information for planning ad campaigns, are known. See, for example, U.S. Patent Application Publication Nos. 2010/0299226 (Steelberg et al.) and 2010/0076838 (Steelberg et al.). However, these systems are not integrated into search engines in a manner that allows search queries to trigger web page displays of brand results.

Search engine results are thus not optimized to assist users in quickly locating the best brands of products and services most liked by the consuming public. The present invention fulfills such a need.

### BRIEF SUMMARY OF THE INVENTION

One preferred embodiment of the present invention provides an automated method for displaying brand results in response to a search query. A search query that includes one or more search terms is received at a processor. The one or more search terms are associated with one or more brands. Brand ratings are retrieved for the one or more brands from a memory that stores brand ratings for a plurality of brands. The brand ratings are based upon an analysis of web content items that mention the brands. A web page display of brand results is generated that shows links to one or more web pages of the one or more brands that the one or more search terms are associated with. The links to the one or more web pages of the brands with the most positive brand rating are displayed first.

Another preferred embodiment of the present invention infers from the user's search query whether the intent of the search query is commercial or informational. If commercial, the search results show brand results. If informational, the search results show organic search results.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

In the drawings:

FIGS. 1 and 2 show a web page of search results that is generated by a conventional search engine.

FIG. 3 is a search query/brand database table that is used to implement one preferred embodiment of the present invention.

FIGS. 4A and 4B are flowcharts of preferred embodiments of the present invention.

FIG. 5 is a keyword database table that is used to implement one preferred embodiment of the present invention.

FIG. 6 is a brand/brand rating database table that is used to implement one preferred embodiment of the present invention.

FIG. 7 shows a web page of brand results that is generated by one preferred embodiment of the present invention.

FIGS. 8 and 9 are flowcharts of preferred embodiments of the present invention.

FIG. 10 shows a schematic diagram of the overall architecture of a system in accordance with one preferred embodiment of the present invention.

FIG. 11 shows a web page of brand results that is generated by another preferred embodiment of the present invention.

FIG. 12 shows a web page of brand results and featured advertisements that is generated by another preferred embodiment of the present invention.

FIG. 13 shows additional details of an advertising module that is part of FIG. 10.

FIG. 14 shows a keyword database table for a web crawler that is used to implement one preferred embodiment of the present invention.

FIG. 15 shows a table that is used to match specific, purchasable products or services offered by a brand with their respective brands, in accordance with one preferred embodiment of the present invention.

### DETAILED DESCRIPTION OF THE INVENTION

Certain terminology is used herein for convenience only and is not to be taken as a limitation on the present invention.

The brand rating examples discussed below and illustrated in the figures are fictitious and do not reflect any views of the inventor or assignee of the patent application, or the patent practitioner who prepared the patent application.

### I. Definitions

The following definitions are provided to promote understanding of the invention.

brand: A brand includes any of the following items: a business, company or manufacturer; a person's name, such as a celebrity or sports figure (e.g., P!nk, Ke$ha, Tiger Woods); or a location (e.g., town, country, region). A brand, as defined herein, is not a specific, purchasable product or service offered by a business, company or manufacturer. Thus, a brand as defined herein is not a trademark or distinctive name of a purchasable product or service, but instead is the business, company or manufacturer that makes or provides the trademarked or distinctively named purchasable product or service. For example, a brand as defined herein is “Apple®” not “iPod®”; Toyota® not Highlander, Verizon®, not FiOS®.

content: includes documents, data, applications, e-services, images, audio and video files, personal Web pages, archived e-mail messages. The content that is processed in preferred embodiments of the present invention is “web content” which is the textual, visual or aural content that is encountered as part of the user experience on websites, and may include text, images, sounds, videos and animations. Web content further includes blog postings, and comments and postings made on social network sites (e.g., Facebook or Twitter posts).

search results (also, referred to as “hits”): A web search engine is designed to search for information on the World Wide Web and FTP servers. The information may include web pages, images, information and other types of files.

brand rating: a rating assigned to a brand based on an analysis of a plurality of positive/negative, and optionally, neutral, comments made regarding the brand, as extracted from web content items. The brand rating may also be referred to as an “affinity rating.”

brand results: A conventional search engine delivers “search results” which match an inputted search query. For example, if a user enters “SUV” as a search query, the search results will include documents that mention the word “SUV.” Sponsored advertisements sometimes do not include the entered search query because a company can purchase advertisements that are triggered based on a specific search query (e.g., GOOGLE AdWords). Brand results are web documents that refer to a brand (as defined above) that is associated with the inputted search query. Brand results are brand-sponsored websites (e.g., www.toyota.com).

### II. Detailed Disclosure

One preferred embodiment of an automated method of displaying brand results in response to a search query operates as follows:

Step 1: Receive a search query. This step may be performed using a conventional search box or search field. A processor (interchangeably referred to hereafter as a “computer”) receives the search query, which is typically inputted into the search box or search field, but which may also be inputted verbally and converted by speech recognition software into a textual query. Alternatively, the search query may be processed in the phonetic domain using phonetic search techniques, as described in U.S. Application Publication No. 2008/0033986 (McCusker et al.), which is incorporated herein by reference. The search query has one or more terms (words or phrases) that can be associated with one or more brands.

Step 2: Identify, using the processor, a subset of web content items that both relate to the search query and mention one or more brands. For example, if the search query includes the word “SUV,” then all web content that has at least one instance of the word “SUV” and, optionally, known permutations of “SUV” (e.g., SUVs, SUV's), are identified as web content items that relate to the search query. The processor further limits the subset to web content items that mention one or more brands. This process may be done simultaneously or in two separate steps. Web content items that relate to the search query, but which do not mention one or more brands (e.g., a web page that includes the sentence “I love my SUV!”), are eliminated from further consideration.

In an alternative embodiment, the processor further identifies web content items that do not have at least one instance of the search query terms, but instead have at least one instance of a brand that is associated with a search query term. These web content items are also web content items that relate to the search query and mention one or more brands. For example, Toyota is a brand that is known to sell SUV's. Thus, a web content item that mentions Toyota, but does not mention the word “SUV,” may also be included in the search results. This embodiment requires the use of an external table that stores search query terms and respective brands associated with the respective search query terms, or an external table (database) that stores brands and search query terms that relate to the respective brands.

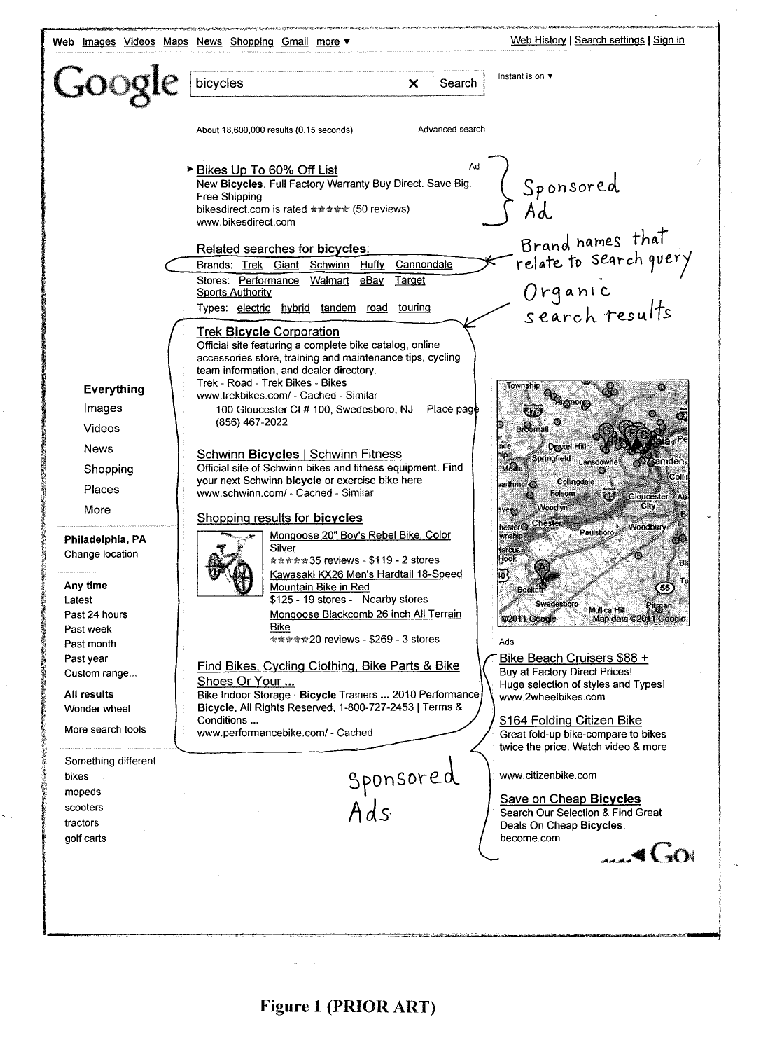

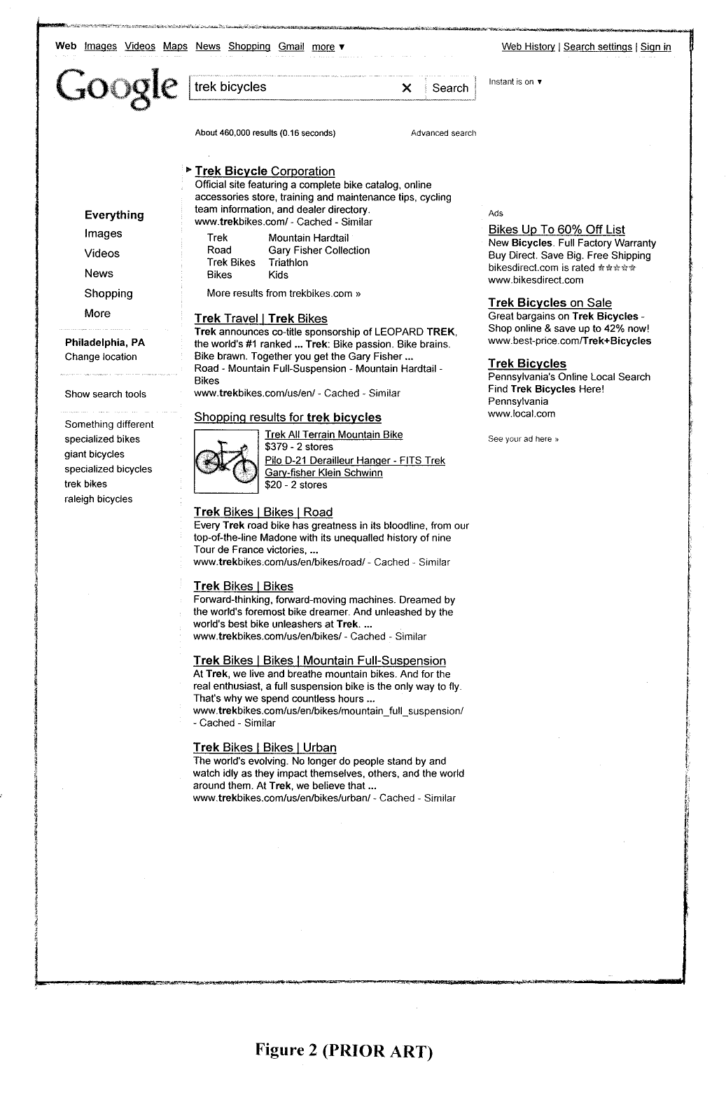

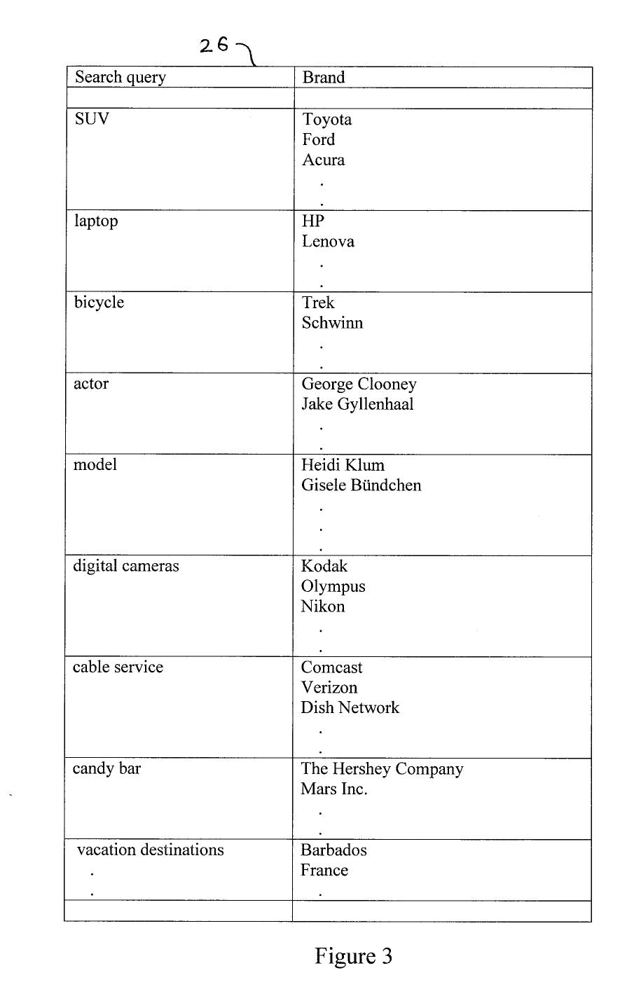

An example of a portion of such an external table wherein a search query is associated with a plurality of brands is shown in FIG. 3. As noted above, the table may also be indexed in reverse wherein each brand has one or more keywords associated with it. GOOGLE's Jazz interface uses a similar type of table (database) to display brand names that relate to a search query. The brand names appear in a separate line on the search result page, but may only be used to formulate a new search. See, for example, FIG. 1 which shows five brand names of bicycles. If a user clicks on a brand name, a new search is automatically formulated that includes the brand name as the first search term, as shown in FIG. 2. The new search results are organic search results related to the new search terms.

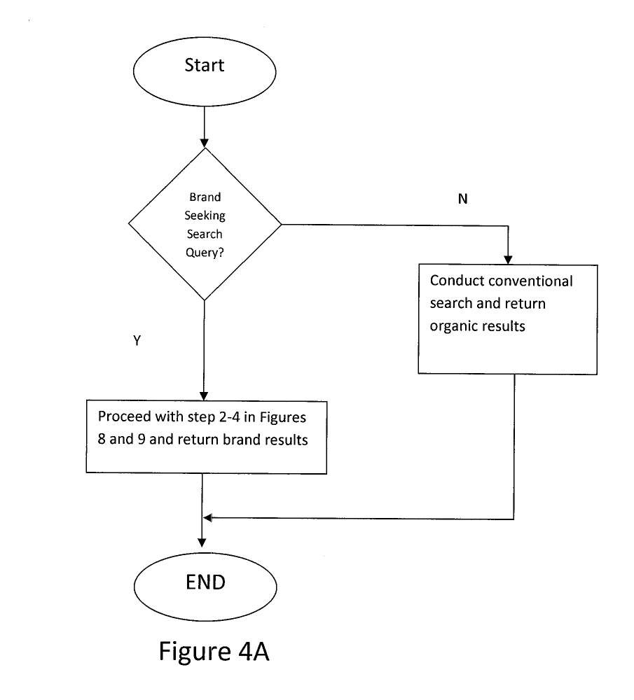

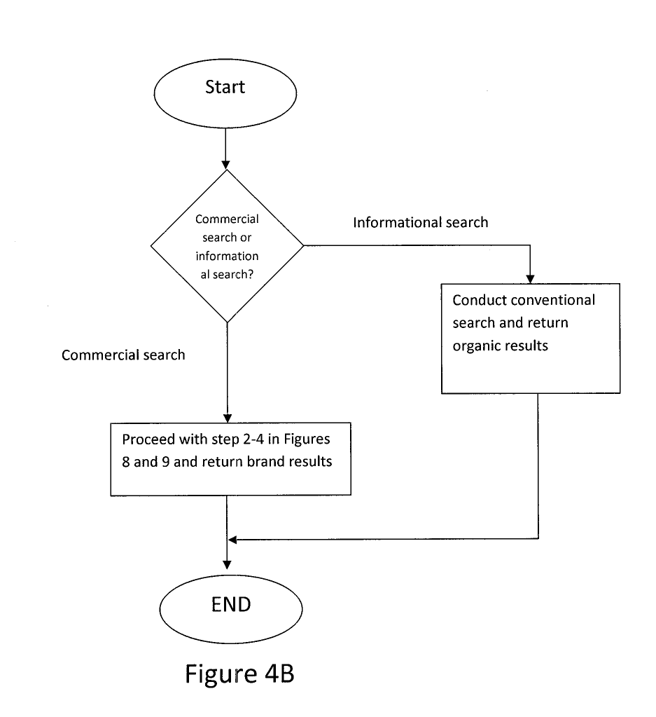

If no brand is associated with the search query through either of the methods described above, then the search query is preferably treated in a conventional manner and returns only organic search results. For example, a search query, “What is the weather in Levittown today?” would not likely identify any brands since “weather” and “Levittown” are not obvious brand-related terms. There may be statistically few or no text excerpts that mention these words in proximity to a brand. Likewise, if the external table is used, no brands may be associated with either of these words. A linguistic engine/cognition engine may be used to make an initial determination regarding whether a search query is seeking brand-related information. If so, then brand results are returned. If not, then organic search results are returned. Such an engine may be needed to resolve the user's intent for certain searches. For example, the search query, “What is the weather in Philadelphia today?” might be confused by the search engine as being a “brand seeking” search query because there are numerous brands associated with “Philadelphia” such as the Philadelphia Eagles, Kraft® (which makes Philadelphia® Cream Cheese), and the like. FIG. 4A shows one preferred embodiment of a flowchart for making an initial decision regarding whether the search engine will treat the search query as a conventional search query or a brand information seeking search query. Steps 2-4 described herein would preferably only be performed if the search query is determined to be a brand information seeking search query.

In an alternative version of FIG. 4A, the decision block labeled “brand seeking search query may be replaced by a decision block labeled “commercial search or informational search?,” wherein the informational search output causes a conventional search to occur which returns organic search results, and a commercial search output cause steps 2-4 to occur which returns brand results. FIG. 4B shows the flowchart for this alternative version. Any of the techniques described above may be used to determine the intent of the user's search query.

Step 3: The processor analyzes the identified subset of web content items to determine a brand rating (affinity rating) for the mentioned brands. In one preferred embodiment, each web content item is analyzed for positive and negative keywords that appear in proximity to the instance of an identified brand. Consider the following made up excerpts that may appear in the same or different web content items:

1. “GM continues to roll out winning vehicles that customers love.”

2. “Verizon FiOS customer service lags behind competition.”

3. “My iPhone is the best cell phone that I ever owned.”

4. “My new iPhone just arrived.”

The first excerpt includes two positive keywords related to the GM brand. The second excerpt includes one negative keyword related to the Verizon brand. The third excerpt includes one positive keyword related to the iPhone product. The fourth excerpt has no obvious positive or negative keywords, and thus would likely be considered to be a neutral sentence. A linguistic engine/cognition engine may be used in conjunction with tagged keywords to extract the likely meaning of excerpts. Such engines may alternatively be used to extract a rating out of an excerpt even if the excerpt has no clear positive or negative keywords. For example, the excerpt, “I replaced my old LG phone with a new iPhone” may be determined to be a positive statement regarding Apple (the brand and seller of the iPhone). Such inferential determinations have a lower degree of certainty, and thus may be weighted differently than excerpts that explicitly include positive or negative keywords. Inferential determinations may also not be needed if there is a statistically significant quantity of excerpts that explicitly include positive or negative keywords.

There are many conventional processes that rate content for positive or negative keywords to determine brand ratings or affinity ratings. Numerous processes which may be used in the present invention are described in U.S. Patent Application No. 2010/0299226 (Steelberg et al.) and 2010/0076838 (Steelberg et al.), which are both incorporated herein by reference.

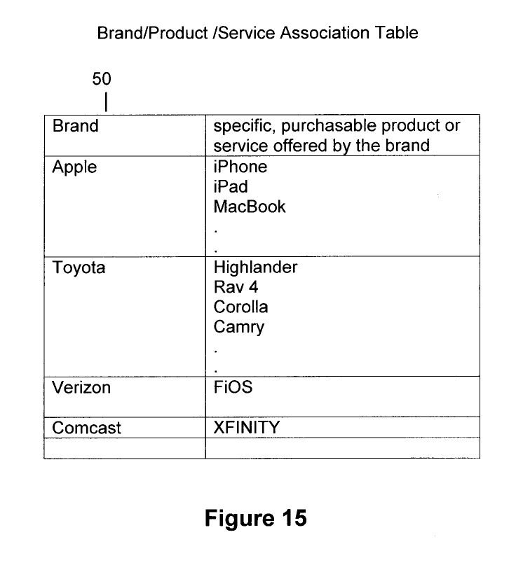

As discussed above, a brand as defined herein is not a trademark or distinctive name of a purchasable product or service, but instead is the business, company or manufacturer that makes or provides the trademarked or distinctively named purchasable product or service. Thus, a database (table) is needed in order to properly classify excerpts that mention a trademark or distinctive name of a purchasable product or service, but which do not mention the business, company or manufacturer that makes or provides the trademarked or distinctively named purchasable product or service. An example of a portion of such a database (table) 50 is shown in FIG. 15. In this manner, excerpts 3 and 4 above would be identified as excerpts regarding the brand, Apple, even though Apple is not mentioned in the excerpt. To further illustrate how table 50 is used, consider the example wherein the search engine query is “SUV.” The table in FIG. 3 identifies various brands that make SUVs. For example, Toyota is one such brand that makes SUVs. When formulating the brand rating for Toyota, excerpts that refer to Toyota are analyzed. In addition, the table 50 provides a listing of specific, purchasable product or service offered by Toyota. Thus, if an excerpt refers to the Highlander without mentioning “Toyota,” the excerpt is included in the brand rating process.

In an alternative embodiment, the table 50 is not used, and the brand ratings are formulated solely from excerpts that explicitly mention a brand. This embodiment will capture a significantly lower quantity of information that is available about brand reputations. However, the quality of the information would likely be greater because excerpts that only mention a brand are likely to provide a better insight in how the public feels about a particular brand, regardless of any specific, purchasable product or service that they offer.

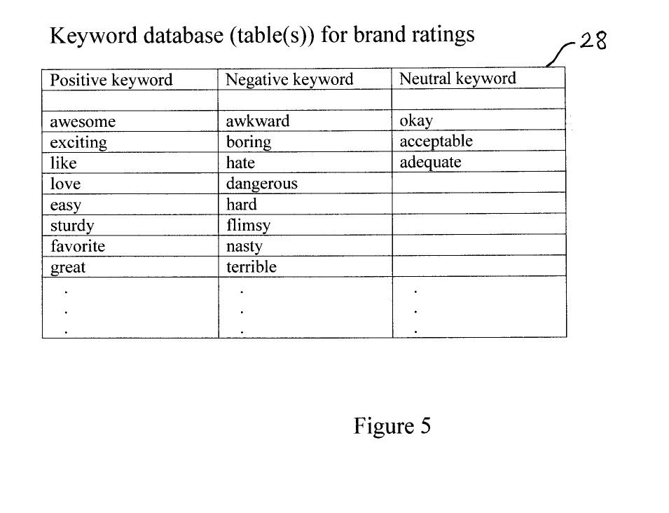

FIG. 5 shows a portion of a sample keyword database (keyword table(s)) that may be used to rate content for positive or negative keywords. The rating process for each excerpt can be simple (+1 for positive, −1 for negative), or it may be highly granular (1-100 score), depending on the qualitative nature of the positive and negative words. No granular rating is shown for the positive, negative or neutral keywords in FIG. 5, although such a rating may be easily assigned by a linguist (e.g., “love” is more positive than “like”; “atrocious” is more negative than “bad”). Neutral keywords may also be used to gauge the number of brand mentions which can be factored into a rating algorithm, as discussed below.

An aggregated rating is created for each brand based on the individual ratings. Many different algorithms can be used to create the aggregated rating and the scope of the present invention is not limited to any particular algorithm. Sample algorithms include:

1. Percentage of positive ratings and/or percentage of negative ratings based on the simple or granular rating.

2. Highest or lowest average granular score.

3. Neutral ratings may also be factored into the algorithm.

4. Total mentions of a brand. The total mentions can be used in a variety of ways. For example, the total mentions of a brand may be used to determine if there is a statistically significant sample of excerpts that mention a brand to make a rating for the brand. If two brands have similar brand ratings and both have a statistically significant sample of excerpts, the total mentions can be used to give a higher rank to the brand that has more mentions when generating the results page discussed in step 4 below.

The excerpts may optionally be weighted based on any number of factors, such as the posting date (newer excerpts could receive greater weightings than older excerpts), source of the excerpt (excerpts from known, unbiased rating services (e.g., Consumer Reports®) may receive greater weighting than postings on social media sites).

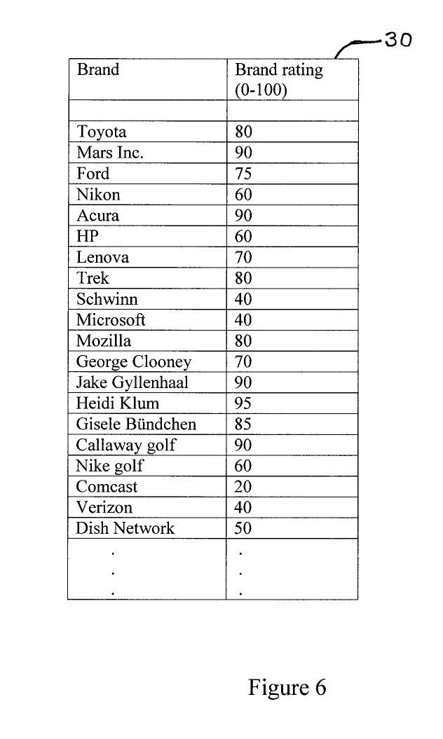

FIG. 6 shows a portion of a sample database of brands and brand ratings at a specific time frame. The brand ratings will change over time.

Step 4: Generate a web page display of brand results (results page) that shows links to one or more web pages of the one or more of the mentioned brands, wherein the links to the one or more web pages of the mentioned brands with the most positive brand rating are displayed first. The links may be accompanied by excerpts or thumbnails of the actual web pages in the same manner as done with certain conventional search engines.

Consider again the example of a search query for “SUV” and a simplified scenario where the only two SUVs on market are Toyota Highlander and Ford Explorer. Referring to FIG. 6, the brand rating for Toyota is 80, whereas the brand rating for Ford is 75. In this example, one or more web pages for Toyota and/or Toyota Highlander will be displayed at the top of the brand results. If Ford Explorer is the only other SUV, then one or more web pages for Ford and/or Ford Explorer will be displayed below the Toyota Highlander web pages.

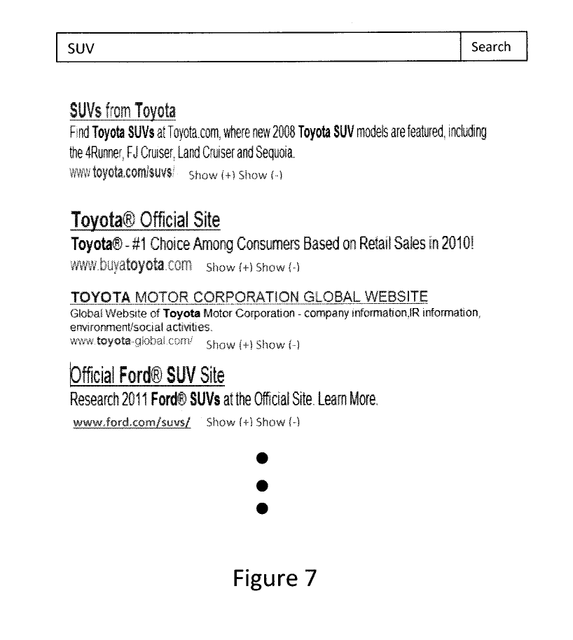

FIG. 7 shows a sample web page of brand results. Additional web pages (not shown) may be required if the number of brand results exceeds the number of results that can be shown on one web page in a manner similar to conventional displays of search engine results. In FIG. 7, the web page display of brand results displays only brand results. However, other embodiments of web page displays are within the scope of the present invention, as discussed below.

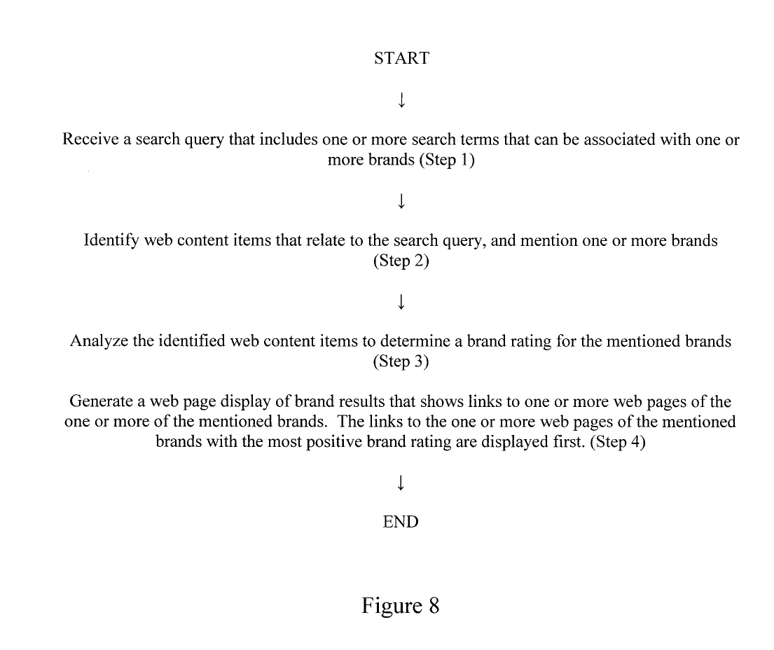

FIG. 8 is a self-explanatory flowchart that summarizes the steps above.

Steps 2 and 3 are preferably periodically performed by the processor for a plurality of search terms that can be associated with one or more brands. A memory then stores the brand ratings for a plurality of brands. The brand ratings are updated in the memory after each periodic performance of steps 2 and 3. Thus, the brand ratings that are used to generate the web page display of brand results in step 4 are immediately available for retrieval when a search query is received at the processor in step 1. In this manner, steps 2 and 3 do not need to be performed between steps 1 and 4, and can be effectively “pre-performed” so that the process can proceed rapidly from steps 1-4.

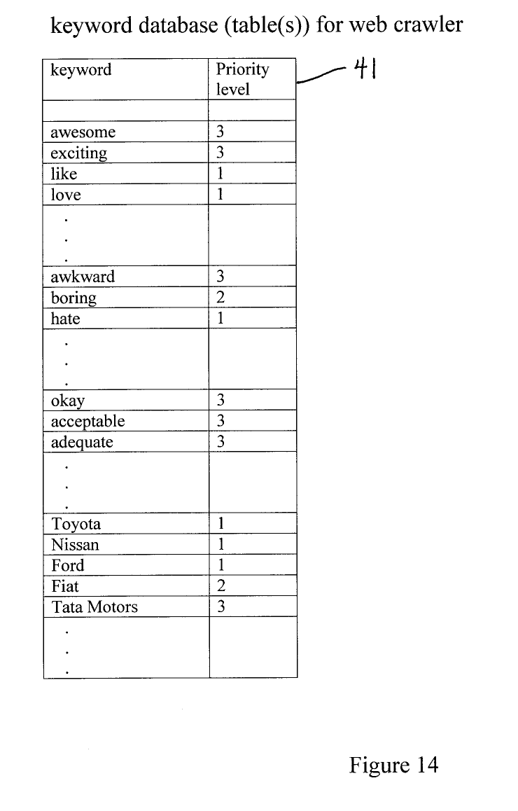

This is similar to the well-known processes performed by web crawlers (also, referred to as automatic indexers and web spiders) and search engine indexers or web indexers. These processes allow search engines to deliver near real-time search results without re-analyzing web content items. The web content items have already been located and indexed, and thus the relevant web content items can be rapidly identified. These processes are well-known, and thus are not described in further detail herein. FIG. 14 shows a keyword database that may be used by a web crawler to locate web content items for generating and maintaining current brand ratings. FIG. 14 is described in more detail below.

One advantage of this type of search engine is that the users/public effectively determine the ranking of results, thereby rewarding companies that have favorably viewed brands. Over time, companies will want to improve the quality of their products and services and thereby improve their ranking in the brand results. As users gravitate towards this type of search engine, companies will no longer be able to rely on large advertising budgets to squeeze out competitors from using web-based platforms for driving customers to their products and services. This process evens out the playing field among competing companies.

Another preferred embodiment of an automated method of displaying brand results in response to a search query operates as follows:

Step 1: Receive a search query. Similar to step 1 above.

Step 2: Associate one or more search terms with one or more brands. This process may be done by any indexing scheme that stores correlations between search terms and brands, or vice-versa. As discussed above and illustrated in FIG. 1, GOOGLE's Jazz interface uses a similar type of table (database) to display brand names that relate to a search query.

If no brand can be associated with one or more of the search terms, then the system preferably treats the search query in a conventional manner and returns only organic search results, as discussed above.

Step 3: Retrieve brand ratings for the one or more brands from a memory that stores brand ratings for a plurality of brands. The brand ratings are based upon an analysis of web content items that mention the brands.

Step 4: Generate a web page display of brand results that shows links to one or more web pages of the one or more brands that the one or more search terms are associated with. The links to the one or more web pages of the brands with the most positive brand rating are displayed first.

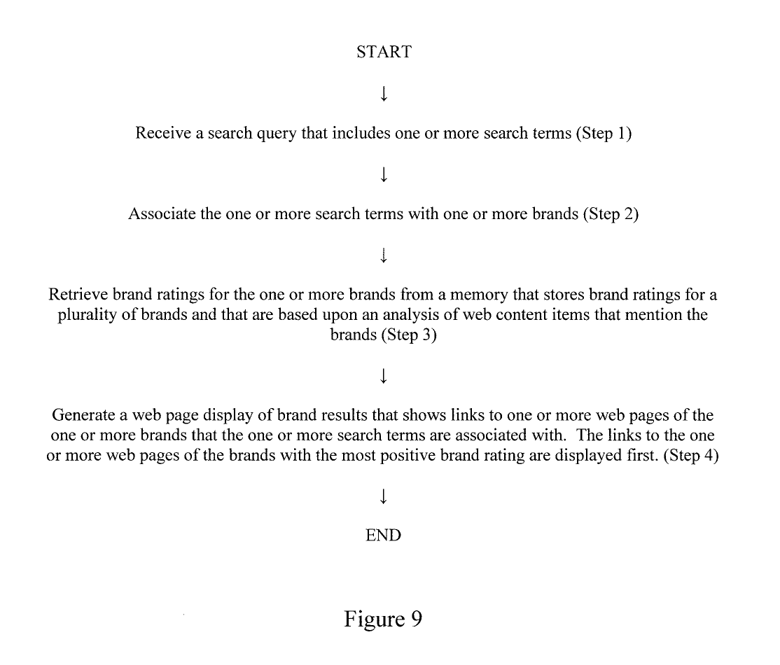

FIG. 9 is a self-explanatory flowchart that summarizes the steps above.

As discussed above, a brand can be a business, company or manufacturer that makes or provides the trademarked or distinctively named purchasable product or service, but can also be a person's name or a location. Thus, search queries such as “best Caribbean island to Visit,” “best vacation destinations,” “best plastic surgeons,” or “top actors” can be handled in the same manner as described above. That is, excerpts that refer to different Caribbean islands, vacation destinations, plastic surgeons, and actors are identified, assigned a brand rating, and then ranked with respect to each other, so that web sites related to the highest rated brand can be retrieved and displayed in response to the search query.

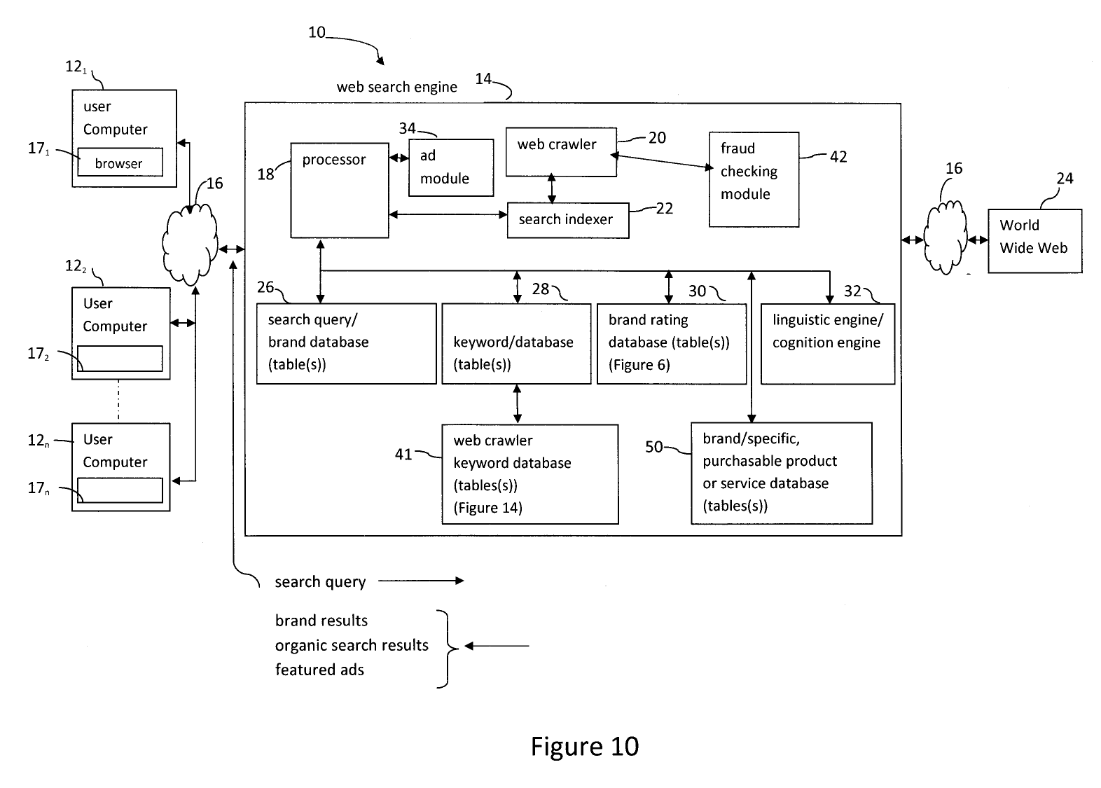

FIG. 10 shows a schematic diagram of the overall architecture of a system 10 in accordance with one preferred embodiment of the present invention. A plurality of user computers 12 are in electronic communication with a web search engine 14 via an electronic network 16, such as the Internet or a LAN. Each of the user computers 12 executes a browser program 17 for interacting with the search engine 14. The search engine 14 includes a processor (computer) 18, and conventional elements such as a web crawler 20 and a search engine indexer 22. The web crawler is in electronic communication with the World Wide Web 24 via the electronic network 16, as is well known in the prior art. The user computers 12 may be desktop computers, laptop computers, mobile devices (e.g., smart phones, tablet computers), and may be wired or wireless devices.

To facilitate the features of the present invention described above, the search engine 14 further includes the following additional elements which are in electronic communication with the processor 18:

search query/brand database (table(s)) 26—FIG. 3

keyword database (table(s)) 28—FIG. 5

brand/specific, purchasable product or service offered by the brand table(s) 50—FIG. 15

brand rating database (table(s)) 30—FIG. 6. The database 30 is the memory referred to above that stores the brand ratings for a plurality of brands.

linguistic engine/cognition engine 32

The processor 18 shown in FIG. 10 may be any general-purpose computer, such as a personal computer (PC) that runs a Microsoft Windows® operating system or a mainframe computer running a UNIX-type operating system. The processor 18 may be one or more servers, which may be centrally located or distributed among different locations.

Alternative embodiments of the present invention are discussed below.

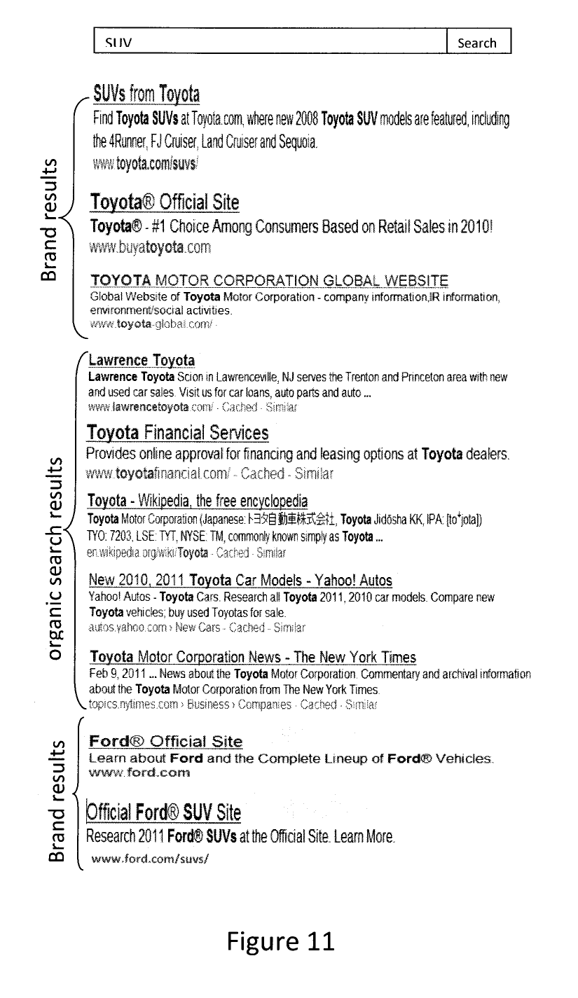

1. Brand results and conventional search results can be displayed together on the results page. For example, the first ten results may include five web pages associated with the most positively rated brands and five web pages that show conventional search results (e.g., the same results that would occur as a result of a GOOGLE search). Alternatively, tabs may be provided to view either all brand results or all conventional search results. FIG. 11 shows a web page of results that is similar to FIG. 7, except that it includes a few top organic search results intermixed between the brand results. One advantage of this embodiment is that if a user's intent was not to seek brand information, even though the search query could be inferred to have that intent, the search engine will still return useful search results. To generate this type of results page, a brand seeking search query (e.g., commercial search) and a conventional organic search (e.g., informational search) is performed, and the combined results are used to generate the result page.

2. Links may be provided next to a brand result to show certain web content items that reflect the ratings of the brand (e.g., show positive web content items, show negative web content items). FIG. 7 shows an example of these links adjacent to each result. They are not shown in FIG. 11 (discussed below), but may also appear in these results.

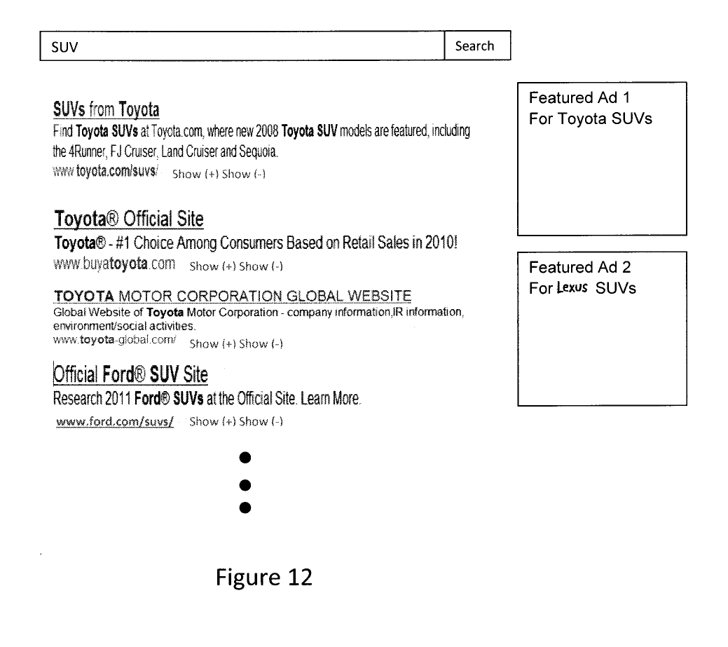

3. Featured advertising. In the preferred embodiment of the present invention, the results page emphasizes brand results. However, brand owners who wish to have advertisements (ads) placed on the results page for their brands may be offered a “seat license” for the privilege of potentially having ads displayed. FIG. 12 shows a web page of results that includes featured advertising from two brands. Consider the example above of the two SUVs. If Toyota and Ford wish to place advertisements for their SUVs, they may pay the “seat license.” In the example above, Toyota's advertisement will appear on the brand results page because it is the highest rated brand at the time in which the brand results page is delivered. A Lexus advertisement will also appear because it is the second highest rated brand at this time. The Ford Explorer advertisement will not be shown because Ford is not one of the top two brands at this time. If the web page was set up to show ads for the top three brands, and if Ford was the third best brand, then the Ford ad would appear, assuming that Ford paid the seat license.

If a brand owner knows that their brand is not well-liked compared to the competition, the brand owner can either not take a “seat license” and forgo ad opportunities with the search engine, or the brand owner can take a different strategy and can identify well-liked brands in non-competing product areas, and launch an ad campaign tied into another high scoring brand. For example, if Nike has a low brand rating, Nike can run an ad campaign that features an actor such as Jake Gyllenhaal who may have a high brand rating for actors so that if the search engine request is a search for “actors,” the Nike ad featuring Jake Gyllenhaal will appear. (Jake Gyllenhaal” would be tagged in the Nike ad, so the ad server would identify this ad as a top-ranked ad to deliver based on the original search request of “actor.”) Of course, Nike would still have to pay for the seat license to buy the potential to have this ad appear. To further explain this process, if the user types in “golf clubs,” the Nike ad would not likely appear even though the ad is tagged for “Nike golf” (as well as Jake Gyllenhaal) because Nike's brand rating is relatively low.

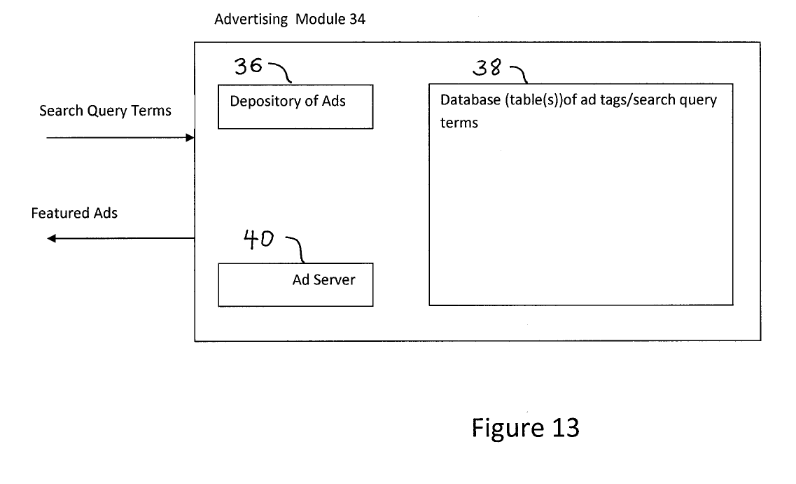

Systems that deliver paid advertisements in conjunction with search engines are well-known in the prior art. U.S. Pat. No. 7,007,074 (Radwin) and U.S. Patent Application Publication No. 2008/0270228 (Dasdan), both of which are incorporated herein by reference, disclose examples of such systems. These systems typically include an advertisement server (ad server), a depository of tagged ads, and an index of search terms or keywords that trigger the potential delivery of selected ads when there is a match between search terms or keywords and the tags of the ads. Similar elements are used in the paid advertising feature of the present invention. FIG. 10 shows an advertisement module 34 that adds this optional feature to the system 10. FIG. 13 shows additional details of the advertisement module 34 which includes the following elements:

Depository of ads 36

database (table(s)) of ad tags/search query terms 38

ad server 40

These elements may also be external to the search engine with electronic communication therebetween. While these individual elements are similar to prior art elements, the ads are not delivered in accordance with conventional processes (e.g., highest bidder for search term or keyword, guaranteed delivery based on contractual arrangement), but instead are delivered based on brand ratings. In one embodiment, only ads from the most positively rated brands are delivered. In another embodiment, the priority of the ads (e.g., order and/or placement on the web page) is determined by the brand rating. Accordingly, the user is more likely to view ads with positive brand ratings (due to preferred placement), or the user will only ads with the most positive brand ratings (if the system is programmed to only deliver ads for the most positively rated brands).

4. The search query and search engine may include a phonetic domain that operates in conjunction with a conventional textual domain. Phonetic search and retrieval techniques are well-known in the prior art, including U.S. Application No. 20080033986, and thus are not described in more detail herein.

5. Search queries may be used to dynamically assist in building the search query/brand database 26 shown in FIG. 3 and the brand database 30 shown in FIG. 6. For example, the linguistic engine/cognition engine 32 may infer from a search query “Toyota Highlander SUV” or “Is Toyota Highlander a good SUV?” that Toyota is a brand that manufactures SUVs. The brand “Toyota” may then be entered into the search query/brand database 26 in conjunction with the search query “SUV.” The brand “Toyota” may then also be entered into the brand database 30.

Search queries may also be used to add new keywords to the keyword database 28 of FIG. 5. However, since the types of keywords in the keyword database 28 can be thoroughly pre-populated by linguists, new adjective-based keywords are not likely to be encountered very often. New slang adjective-based keywords may be detected, but a slang dictionary or human intervention would likely be needed to properly identify the adjective as belonging in the keyword database 28 and to categorize the keyword as being positive, negative or neutral.

Search queries may be used to dynamically assist in building the brand/product/service association table of FIG. 15. For example, the linguistic engine/cognition engine 32 may infer from a search query “Toyota Highlander SUV” or “Is Toyota Highlander a good SUV?” that the Highlander is a product manufactured by the brand Toyota. The product “Highlander” may then be entered into the table of FIG. 15 as a specific, purchasable product offered by the brand Toyota.

6. Third-party entity participation. Brand ratings may be obtained from third-party entities that compile such ratings as part of their business. Thus, it may not be necessary for the search engine 14 to perform the above-described steps to create the brand ratings. In this alternative embodiment, the search engine 14 either directly accesses a brand rating database 30 hosted by the third-party entity, or periodically receives a copy of the third-party database to load into the brand rating database 30. Likewise, the search query/brand database 26 and/or the keyword database 28 may be developed and/or maintained by a third-party entity and accessed/received in a similar manner by the search engine 14 as the brand rating database 30.

7. The web crawler process described above for creating and maintaining current brand ratings may use a selection of keywords to periodically crawl the web for relevant brand-related excerpts. FIG. 14 shows a keyword database 41 for use by the web crawler 20. The adjective-based keywords in FIG. 5 are preferably a subset of the keywords used in this process, as shown in the first subset of keywords in FIG. 14. Alternatively, the keyword database 41 may be completely separate from the keyword database in FIG. 5. FIG. 14 also includes additional brand-based keywords (brand keywords) which constitute a second subset of keywords. The web crawler keyword database 41 preferably also includes a priority level that is used to determine the frequency of crawling. For example, a keyword that has a priority level of 1 may be searched for every five minutes, whereas a keyword that has a priority level of 3 may be searched for every 24 hours. Multiple instances of web crawlers 20 may be used, wherein each instance of a web crawler is assigned to a respective priority level and searches only the keywords that have the assigned priority level. As is well-known in the prior art, web crawlers continually update their search of the web and index or re-index only new sites or sites with changed content with each successive crawl so that search engines can deliver up-to-date search results. A similar process is used herein so that the brand results are up-to-date.

Search queries are preferably used to populate the web crawler keyword database 41 and to assign the priority levels. The more frequent that a search term appears, the higher priority level it will receive. Some priority levels may also be manually assigned. If a brand is identified in a search query that is not in the web crawler keyword database 41, the brand may be added with a default priority level which is then subsequently determined automatically based on its frequency of appearance in subsequent search queries. In one embodiment, the default priority level may be the highest priority level (here, level 1) so that any web postings related to new brands are immediately captured and reflected in the brand ratings.

Search queries may also be used to add new adjective-based keywords to the web crawler keyword database 41, but as discussed above, new adjectives are much less likely to be encountered than new brand keywords. New slang adjective-based keywords may be detected, but a slang dictionary or human intervention would likely be needed to properly identify the adjective as belonging in the database 41.

This web crawling embodiment is more robust than the web crawling embodiment described above for maintaining the brand ratings because it allows brand keywords (not just adjective-based keywords) to control the crawling frequency and because it allows different keywords to have different priority levels. In this manner, brand results can rapidly reflect any fast-paced changes to a brand's reputation, and immediate feedback can be received on new brands. Likewise, processor overhead used for web crawling can be reduced for low priority keywords. While this web crawler process is more robust than a process that does not factor in priority and crawls for only adjective-based keywords, it still is part of the same overall process which is that brand results are determined by locating web content items that both (i) relate to the search query, and (ii) mention one or more brands. These identified web content items are then analyzed to determine a brand rating for the mentioned brands.

In an alternative version of this embodiment, the web crawler process initiates searches for only the brand keywords in the keyword database 41, and does not use the adjective-based keywords in the crawling process. The keywords in the keyword database 28 of FIG. 5 are still used for identifying web content items that relate to the search query and mention one or more brands (here, the brand keywords) so that the identified web content items can be analyzed to determine a brand rating for the mentioned brands.

8. Fraud detection/prevention. The web search engine 14 in FIG. 10 may include a fraud checking module 42 to detect attempts by brand owners, competitors of brand owners, and members of the public to plant large numbers of positive or negative comments about brands so as to influence a brand rating. Some methods for fraud detection/prevention are as follows:

i. Identical excerpts that appear on multiple sites may be counted only once. This method will also capture identical excerpts that are populated on multiple sites as part of an automated process that is not even intended to influence a brand rating, such as two different websites that have agreed to share access to user postings. The linguistic engine/cognition engine 32 may also be used to detect near identical excerpts so that minor word changes cannot be used to avoid detection.

ii. Excerpts that are attributed to the same entity may be flagged and counted only once.

iii. Posting date information may further be used by the fraud checking module 42 to assist in determining if a posting is from an actual person.

If an excerpt is flagged as being very likely to have not been posted from an actual person, it may alternatively not be counted at all.

The present invention may be implemented with any combination of hardware and software. If implemented as a computer-implemented apparatus, the present invention is implemented using means for performing all of the steps and functions described above.

When implemented in software, the software code can be executed on any suitable processor or collection of processors, whether provided in a single computer or distributed among multiple computers.

The present invention can also be included in an article of manufacture (e.g., one or more computer program products) having, for instance, computer readable storage media. The storage media has computer readable program code stored therein that is encoded with instructions for execution by a processor for providing and facilitating the mechanisms of the present invention. The article of manufacture can be included as part of a computer system or sold separately.

The storage media can be any known media, such as computer memory, one or more floppy discs, compact discs, optical discs, magnetic tapes, flash memories, circuit configurations in Field Programmable Gate Arrays or other semiconductor devices, or other tangible computer storage medium. The storage media can be transportable, such that the program or programs stored thereon can be loaded onto one or more different computers or other processors to implement various aspects of the present invention as discussed above.

The computer used herein may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile, or fixed electronic device.

The computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention.

What is claimed is:

1. An automated method of displaying brand results in response to a search query, the method comprising:
(a) receiving a search query at a processor, the search query including one or more search terms;
(b) associating the one or more search terms with one or more brands;
(c) retrieving brand ratings for the one or more brands from a memory that stores brand ratings for a plurality of brands, the brand ratings being based upon an analysis of web content items that mention the brands; and
(d) generating, using the processor, a web page display of brand results that shows links to one or more web pages of the one or more brands that the one or more search terms are associated with, wherein the links to the one or more web pages of the brands with the most positive brand rating are displayed first.

2. The method of claim 1 further comprising:
(e) retrieving search results that include one or more of the search terms in the search query, and wherein step (d) further comprises generating, using the processor, a web page display of brand results that shows:
(i) links to one or more web pages of the one or more brands that the one or more search terms are associated with, and
(ii) links one or more of the retrieved search results that include one or more of the search terms in the search query.

3. The method of claim 1 further comprising:
(e) retrieving from an ad server one or more featured advertisements that:
(i) are from the one or more brands that the one or more search terms are associated with, and
(ii) have the most positive brand rating of the brands, and
wherein step (d) further comprises generating, using the processor, a web page display of brand results that shows:
(i) links to one or more web pages of the one or more brands that the one or more search terms are associated with, and
(ii) one or more of the retrieved featured advertisements.

4. The method of claim 1 wherein the web page display of brand results generated in step (d) includes a link to one or more positive excerpts regarding the brand.

5. The method of claim 1 wherein the web page display of brand results generated in step (d) displays only brand results.

6. An automated method of displaying brand results in response to a search query, the method comprising:
(a) receiving a search query at a processor, the search query including one or more search terms that can be associated with one or more brands;
(b) identifying, using the processor, web content items that:
(i) relate to the search query, and
(ii) mention one or more brands;
(c) analyzing, using the processor, the identified web content items to determine a brand rating for the mentioned brands; and
(d) generating a web page display of brand results that shows links to one or more web pages of the one or more of the mentioned brands, wherein the links to the one or more web pages of the mentioned brands with the most positive brand rating are displayed first.

7. The method of claim 6 further comprising:
(e) retrieving search results that include one or more of the search terms in the search query, and wherein step (d) further comprises generating, using the processor, a web page display of brand results that shows:
(i) links to one or more web pages of the one or more of the mentioned brands, and
(ii) one or more of the retrieved search results that include one or more of the search terms in the search query.

8. The method of claim 6 further comprising:
(e) retrieving from an ad server one or more featured advertisements that:
(i) are from the one or more brands that the one or more search terms are associated with, and
(ii) have the most positive brand rating of the brands, and
wherein step (d) further comprises generating, using the processor, a web page display of brand results that shows:
(i) links to one or more web pages of the one or more of the mentioned brands, and
(ii) one or more of the retrieved featured advertisements.

9. The method of claim 6 wherein steps (b) and (c) are periodically performed by the processor for a plurality of search terms that can be associated with one or more brands, the method further comprising:
(e) retrieving brand ratings for the one or more brands from a memory that stores brand ratings for a plurality of brands, the brand ratings being updated after each periodic performance of steps (b) and (c), wherein the brand ratings are retrieved when a search query is received at the processor in step (a) and used to generate the web page display of brand results in step (d).

10. The method of claim 6 wherein the web page display of brand results generated in step (d) includes a link to one or more positive excerpts regarding the brand.

11. A computer program product for displaying brand results in response to a search query, the computer program product comprising computer-readable media encoded with instructions for execution by a processor to perform a method comprising:
(a) receiving a search query, the search query including one or more search terms;
(b) associating the one or more search terms with one or more brands;
(c) retrieving brand ratings for the one or more brands from a memory that stores brand ratings for a plurality of brands, the brand ratings being based upon an analysis of web content items that mention the brands; and
(d) generating a web page display of brand results that shows links to one or more web pages of the one or more brands that the one or more search terms are associated with, wherein the links to the one or more web pages of the brands with the most positive brand rating are displayed first.

12. The computer program product of claim 11 wherein the instructions for execution by the processor perform a method further comprising:
(e) retrieving search results that include one or more of the search terms in the search query, and wherein step (d) further comprises generating a web page display of brand results that shows:
(i) links to one or more web pages of the one or more brands that the one or more search terms are associated with, and
(ii) links one or more of the retrieved search results that include one or more of the search terms in the search query.

13. The computer program product of claim 11 wherein the instructions for execution by the processor perform a method further comprising:
(e) retrieving from an ad server one or more featured advertisements that:
(i) are from the one or more brands that the one or more search terms are associated with, and
(ii) have the most positive brand rating of the brands, and
wherein step (d) further comprises generating a web page display of brand results that shows:
(i) links to one or more web pages of the one or more brands that the one or more search terms are associated with, and
(ii) one or more of the retrieved featured advertisements.

14. The computer program product of claim 11 wherein the web page display of brand results generated in step (d) includes a link to one or more positive excerpts regarding the brand.

15. The computer program product of claim 11 wherein the web page display of brand results generated in step (d) displays only brand results.
